(19) United States
(12) Patent Application Publication
(10) Pub. No.: US 2023/0254556 A1
(43) Pub. Date: Aug. 10, 2023

(54) SENSOR MAINTENANCE

(71) Applicant: Zimeno, Inc. dba Monarch Tractor, Livermore, CA (US)

(72) Inventor: Zachary Meyer OMOHUNDRO, Livermore, CA (US)

(73) Assignee: Zimeno, Inc. dba Monarch Tractor, Livermore, CA (US)

(21) Appl. No.: 18/164,597

(22) Filed: Feb. 5, 2023

Related U.S. Application Data
(60) Provisional application No. 63/306,522, filed on Feb. 4, 2022.

(51) Int. Cl. H04N 23/52; H04N 23/90; B62D 25/06

(52) U.S. Cl. CPC H04N 23/52; H04N 23/90; B62D 25/06

(57) ABSTRACT

A sensor maintenance system may include a sensor having an exterior, a heat exchanger to output exhaust air and a conduit for directing the exhaust air to regions proximate the exterior of the sensor.

### CROSS-REFERENCE TO RELATED PATENT APPLICATIONS

The present application patent application claiming priority under 35 USC 119 from co-pending U.S. Provisional Patent Application Ser. No. 63/306,522 filed on Feb. 4, 2022, by Zachary Meyer Omohundro and entitled SENSOR MAINTENANCE, the full disclosure of which is hereby incorporated by reference.

### BACKGROUND

Vehicles often include sensors to detect the surrounding environment to assist an operator and controlling the vehicle and/or to autonomously control particular operations of the vehicle. Moisture, airborne contaminants and the like may impair the ability of the sensors to reliably and accurately sense the surrounding environment.

### BRIEF DESCRIPTION OF THE DRAWINGS

FIG. 1 is a diagram schematically illustrating portions of an example sensor maintenance system.

FIG. 2 is a diagram schematically illustrating portions of an example sensor maintenance system.

FIG. 3 is a flow diagram of an example sensor maintenance method.

FIG. 4 is a top perspective view of an example vehicle including an example sensor maintenance system.

FIG. 5 is a rear perspective view of the example vehicle of FIG. 4.

FIG. 6 is a partially exploded perspective view of an example roof of the example vehicle of FIG. 4.

FIG. 7 is a partially exploded perspective view of the example roof of the example vehicle of FIG. 4.

FIG. 8 is a partially exploded perspective view of the example roof of the example vehicle of FIG. 4.

FIG. 9 is a sectional view of the example roof of the example vehicle of FIG. 4.

Throughout the drawings, identical reference numbers designate similar, but not necessarily identical, elements. The Figures. are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF EXAMPLES

Disclosed are example sensor maintenance systems and methods for maintaining performance of a sensor in the presence of moisture and airborne contaminants. The disclosed systems and methods may direct air towards, onto and/or about the sensor to remove any accumulated moisture or airborne contaminants on the sensor, its sensing face or other sensing surface. In some implementations, the disclosed system methods form a wall or air curtain in front of the sensor or its sensing face to inhibit accumulation of moisture or airborne contaminants on the sensor or its sensing face. The disclosed sensor maintenance systems and methods are especially beneficial in construction and agricultural vehicles which may operate in environments where airborne contaminants, such as dust and chaff, are prevalent.

The example sensor maintenance systems and methods provide compact and cost-effective maintenance of the sensor. The example sensor maintenance systems and methods utilize air exhausted from a heat exchanger to maintain the sensor. A conduit directs the exhaust air from the heat exchanger to regions proximate an exterior of the sensor to maintain the sensor.

A heat exchanger is generally used to transfer heat between fluids, such as liquids or gases (air). Some heat exchangers may include coils through which a coolant flows, wherein air is blown or otherwise directed directly across the coils to absorb and remove heat from the coolant. In some heat exchangers, air may be extracted from the coolant within the coils by heat sink provided by a series of pins, fins or other structures that are formed from highly thermally conductive materials, wherein air is blown and directed across the heat sink to extract heat from the heat sink. Some heat exchangers may include a thermoelectric cooling device, sometimes referred to as a Peltier device, to assist in extracting heat or cooling a heat emitting component, wherein the warm or hot side of the thermoelectric cooling device is cooled by directing air across the hot side of the thermoelectric cooling device or by positioning a heat sink adjacent the hot side and directing air across the heat sink to absorb and extract heat from the heat sink. Some heat exchangers may include a heat sink thermally coupled, directly or indirectly, to a heat emitting component so as to absorb heat from the heat emitting component. Air may be blown or directed across the heat sink to absorb heat from the surfaces of the heat sink.

Air that has absorbed heat from the heat exchanger, such as from a heat sink or hot side of a thermoelectric cooling device, is sometimes exhausted or discharged to the general environment surrounding the vehicle. In contrast to such systems, the disclosed sensor maintenance systems recycle or utilize the exhausted air to maintain performance of the sensor. Because the air being exhausted from the heat exchanger is already under pressure, being blown by fan across or through the heat exchanger, the airflow of exhaust air may be easily redirected or routed for use in removing moisture and airborne contaminants from a sensor and/or for inhibiting the accumulation of moisture or airborne contaminants on the sensor. Dedicated fans or blowers for otherwise directing air to maintain performance of the sensor may be eliminated or reduced, reducing the cost and complexity of the vehicle and its sensing systems.

The disclosed example sensor maintenance systems and methods compactly arrange the heat exchanger, the fan for directing air through or across a heat exchanger and the sensor itself to reduce air pressure losses as well as to reduce cost and complexity of the sensor maintenance system. In some implementations, the sensor is supported on the roof of the vehicle, such as along a front or rear edge of the roof. The sensor may be in the form of a camera to capture infrared or (red-green-blue) RGB images of the vehicle surroundings. By positioning the sensor on the roof of the vehicle, the sensor may have a wider field of view to better capture the surroundings of the vehicle.

In such implementations, the roof of the vehicle may further support various heat emitting components. For example, in some implementations, the roof of the vehicle may include a printed circuit board or multiple printed circuit boards that have microprocessors (processing units) for controlling operations of the vehicle. Such microprocessors emit heat. To prevent overheating or damage to such microprocessors, heat sinks are used to extract or draw heat away from the microprocessors, wherein fans are used to direct air across the heat sinks to extract heat from the heat sinks. This pressurized airflow is directed by a conduit towards or proximate to the roof mounted sensor to maintain performance of the sensor in the presence of moisture or airborne contaminants. Because such components are provided in a compact arrangement in the roof, pressure losses are reduced. The extent of complex and cost increasing piping, plenums and the associated potentially troublesome seals for directing the airflow may also be reduced or avoided.

Disclosed is an example sensor maintenance system which may include a sensor having an exterior, a heat exchanger to an output exhaust air, and a conduit for directing the exhaust air to regions proximate the exterior of the sensor. In some implementations, the heat exchanger may comprise a heat sink and a fan to direct air across the heat sink. In some implementations, the heat sink is thermally coupled to a heat emitting component such as a printed circuit board supporting at least one microprocessor for controlling operations of the sensor or other operations of the vehicle. In some implementations, the sensor, the heat exchanger, the conduit and the printed circuit board are supported by a roof of the vehicle. In some implementations, the roof may support a pair of cameras, a first camera facing forwardly and a second camera facing rearwardly, wherein the exhaust air from cooling systems of the vehicle are directed at an/or across the sensing face of the cameras to maintain the cameras in the presence of moisture and/or airborne debris.

Disclosed is an example sensor maintenance method. The method may include directing cooling air across a heat exchanger surface that has absorbed heat from a heat emitting component. The method may further include directing exhaust air from heat exchanger to regions proximate an exterior of a sensor. In some implementations, a fan may be used to direct the cooling air across the heat sink. In some implementations, the sensor may be supported by roof of a vehicle. In some implementations, the sensor may comprise a camera, wherein the exhaust air is directed so as to form an air curtain across the face of the camera.

FIG. 1 is a diagram schematically illustrated portions of an example sensor maintenance system 20. System 20 comprises sensor 30, heat exchanger 34 and conduit 38. Sensor 30 comprise a device to sense a surrounding environment and to output signals indicating the sensed values. Sensor 30 may be vulnerable to performance degradation in the presence of moisture and airborne contaminants. In one implementation, sensor 30 comprises a camera. In some implementations, sensor 30 comprises an infrared camera. In some implementations, sensor 30 comprises a stereo camera. In some implementations, sensor 30 may comprise other forms of sensing devices.

Heat exchanger 34 comprise a device configured to absorb and remove or extract heat from a heat emitting component 32 (shown in broken lines). Heat exchanger 34 has a surface to which the heat from the heat emitting component has been thermally conducted and spread, wherein an airflow across the surface may remove the heat for discharge. In some implementations, heat exchanger 34 comprises at least one fan or blower for directing the airflow through or across the surface to remove the heat. In some implementations, heat exchanger 34 may comprise coils through which a coolant flows, wherein air is blown or otherwise directed directly across the coils to absorb and remove heat from the coolant. In some implementations, air may be extracted from the coolant within the coils by a heat sink provided by a series of pins, fins or other structures that are formed from highly thermally conductive materials, wherein air is blown and directed across the heat sink to extract heat from the heat sink. In some implementations, heat exchanger 34 may comprise a thermoelectric cooling device, sometimes referred to as a Peltier device, to assist in extracting heat from a heat emitting component, wherein the warm or hot side of the thermoelectric cooling device is cooled by directing air across the hot side of the thermoelectric cooling device or by positioning a heat sink adjacent to the hot side and directing air across the heat sink to absorb and extract heat from the heat sink. In some implementations, heat exchanger 34 may comprise a heat sink thermally coupled, directly or indirectly, to heat emitting component 32 so as to absorb heat from the heat emitting component 32.

The heat emitting component 32 may comprise any electronic component that generates heat. Such heat may degrade performance of the heat emitting component 32. In some implementations heat emitting component 32 comprises electronics such as a processing unit for controlling sensor 30 and/or processing data received from sensor 30. In some implementations, heat emitting component 32 may control the operation of an/or process data from other sensor devices. In some implementations, the heat emitting component 32 may comprise a battery or a pack of batteries, such as lithium-ion batteries, that emit heat during the flow of electrical current.

Conduit 38 comprises an airflow passage formed by plenums, piping, walls or the like. Conduit 38 directs the heated air exhausted from heat exchanger 34, the exhaust air, to regions proximate an exterior of sensor 30. In some implementations, conduit 38 comprises an outlet adjacent to or proximate to a sensing face 40 of sensor 30. In some implementations, the airflow output by conduit 38 is directed onto or across the sensing face 40 of sensor so as to remove any moisture or airborne contaminants 43 which may have accumulated on the sensing face 40 of sensor 30. In some implementations, conduit 38 may comprise nozzles. In some implementations, conduit 38 may have an outlet configured to form a curtain 45 of airflow that may inhibit or block airborne contaminants or moisture 47 from coming into contact with sensing face 40 of sensor 30.

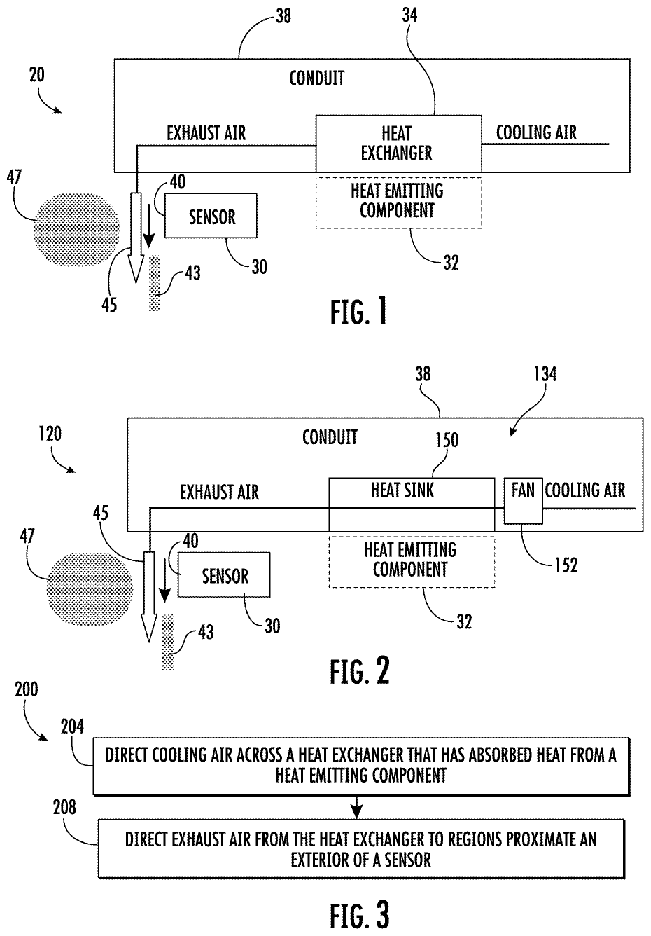

FIG. 2 schematically illustrates an example sensor maintenance system 120. FIG. 2 illustrates an example of a particular heat exchanger that may be utilized as part of a sensor maintenance system. System 120 is similar to system 20 described above except that system 120 particular comprises heat exchanger 134. As shown by FIG. 2, heat exchanger 134 comprises heat sink 150 and fan 152.

Heat sink 150 comprises a set of pins, fins or other structures formed from a highly thermally conductive material, such as copper, aluminum or the like, which are thermally coupled to heat emitting component 32. For purposes of this disclosure, the term “thermally coupled” means that two items are connected directly or indirectly (with at least one intervening component) such that heat may be thermally conducted between the two items. In some implementations, heat sink 150 is positioned in direct contact with heat emitting component 32. In other implementations, heat sink 150 may be indirectly thermally coupled to heat emitting component 32 by a thermal interface material formed or positioned between the back face of the heat sink (opposite to the fins or pins) and the heat emitting face of the heat emitting component 32.

Fan 152 comprises a device configured to generate pressurized airflow through and/or across the fins or pins of heat sink 150. The airflow generated by fan 152 is further directed by conduit 38 to regions proximate to the exterior or sensing face of sensor 30 as described above. In some implementations, fan 152 may draw air through a filter prior to directing the air through an/or across heat sink 150 and towards sensing face 40 of sensor 30.

Method 200 is a flow diagram of an example sensor maintenance method 200. Method 200 facilitates enhanced performance of sensor 30 by reducing performance degradation of sensor 30 caused by moisture and/or airborne contaminants such as dust and chaff. Although method 200 is described in the context of being carried out by systems 20 and 120, method 200 may likewise be carried out with other similar sensor maintenance systems.

As indicated by block 204, cooling air at a first temperature is directed across a heat exchanger 34, 134 that has absorbed heat from a heat emitting component 32. As shown in FIG. 2, the heat exchanger may include a fan 152 which directs the cooling air through or across heat sink 150, wherein heat sink 150 has absorbed heat from heat emitting component 32.

As indicated by block 208, conduit 38 may direct air from heat exchanger 34, 134 to regions proximate an exterior, or a sensing, of sensor 30. The air may be in the form of a stream or curtain proximate to sensing face 40 of sensor 30. The air flow may remove any moisture or airborne debris that has accumulated on the sensing face 40 of sensor 30. The air flow may form a transparent wall for blocking moisture or airborne contaminants from contacting the sensing face 40 of sensor 30.

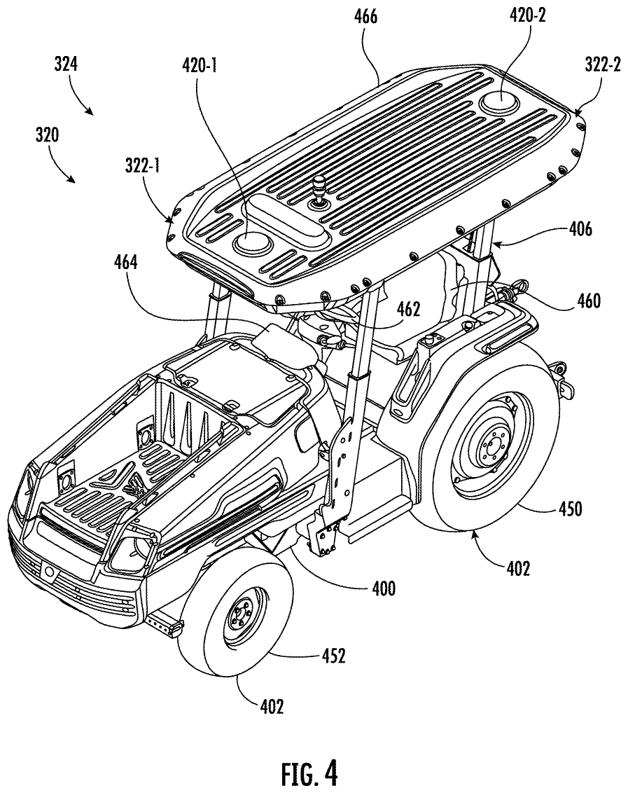

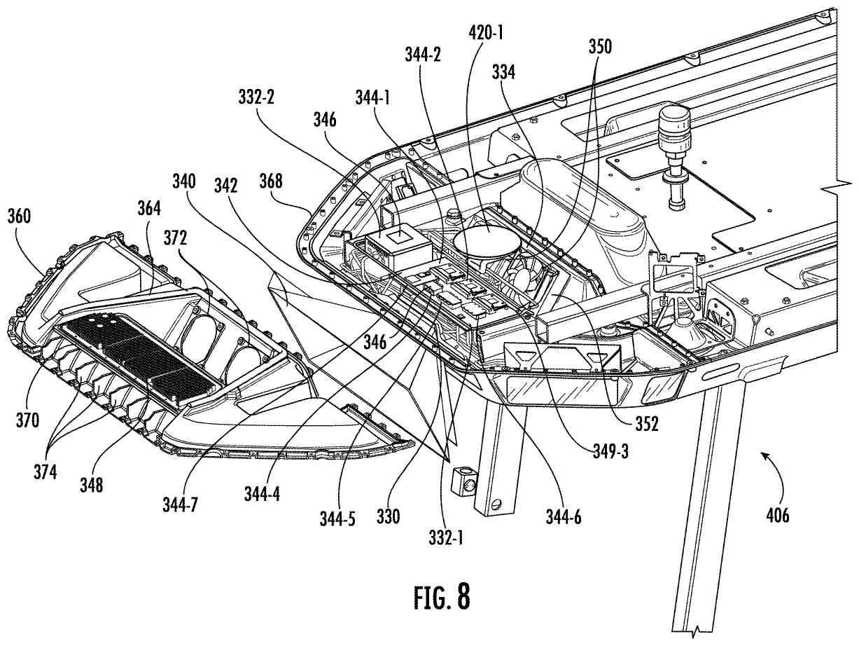

FIGS. 4-9 illustrate portions of an example sensor maintenance system 320. FIGS. 4-9 illustrate an example of a sensor maintenance system incorporated as part of a vehicle in the form of a tractor 324. In other implementations, the disclosed example sensor maintenance system may be incorporated as part of other vehicles, especially those vehicles that may work in environments where airborne contaminants and/or moisture are prevalent. For example, disclose example sensor maintenance systems may likewise be especially beneficial on construction equipment.

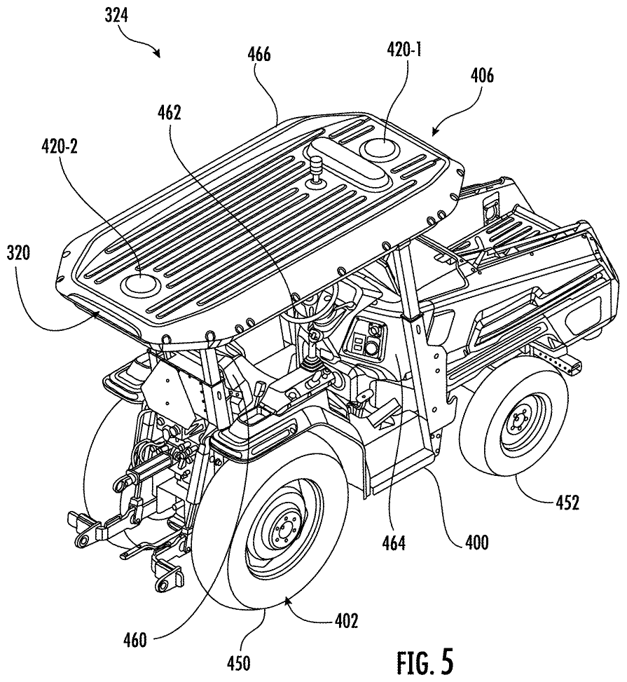

As shown by FIGS. 4 and 5, in addition to sensor maintenance system 320, tractor 324 comprises chassis 400, ground propulsion members 402, vehicle cab 406, and global positioning system (GPS) units 420-1 and 420-2 (collectively referred to as GPS units 420). Chassis 400 comprises the main frame supporting the remaining components of tractor 324.

Ground propulsion members 402 comprise members that engage the underlying terrain and which are driven by an electric motor, internal combustion engine or combinations thereof. In the example illustrated, ground propulsion members 402 comprise rear wheels 450 and front wheels 452. In the example illustrated, rear wheels 450 are driven by an electrical drive while front wheels 452 are manipulated or turned by an automated steering control system or by operating input using a steering wheel or other input device. In other implementations, ground propulsion members 402 may comprise tracks or other ground engaging members.

Cab 406 comprises a compartment in which an operator may be seated when operating tractor 324. Cab 406 comprises a seat 460, a steering wheel 462, a control console 464 and a roof 466. Roof 466 extends over control seat 460 and control console 464. In some implementations, roof 466 may be raised and lowered.

GPS units 420 are supported by roof 466. Each of GPS units 420 comprises a GPS antenna. In the example illustrated, GPS unit 420-1 is located at a front end of roof 466, forward of a rear axle while GPS unit 420-2 is located at a rear end of roof 466, rearward of the rear axle. GPS units 420 receive signals from satellites, from which the geographical location of tractor 324, such as defined by its base link or rear axle center, may be determined. In some implementations, tractor 324 may comprise a single GPS antenna.

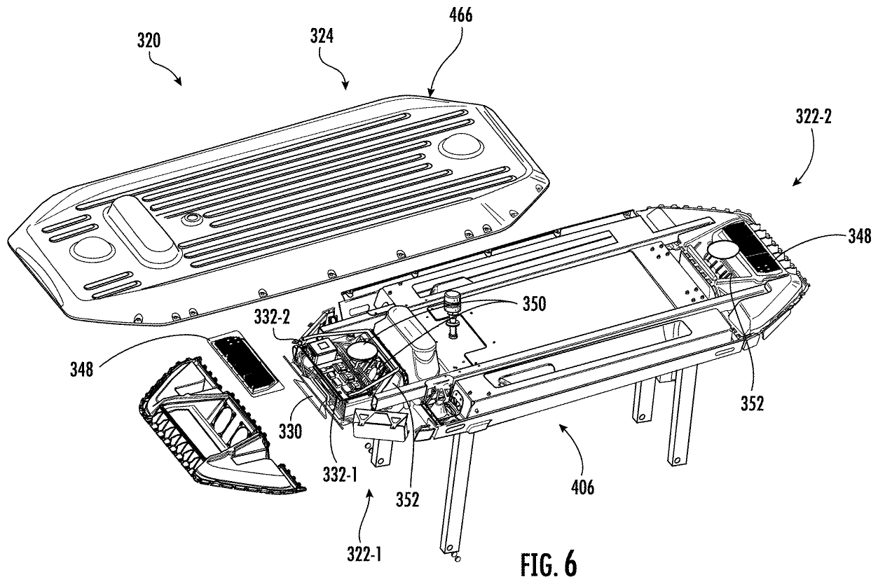

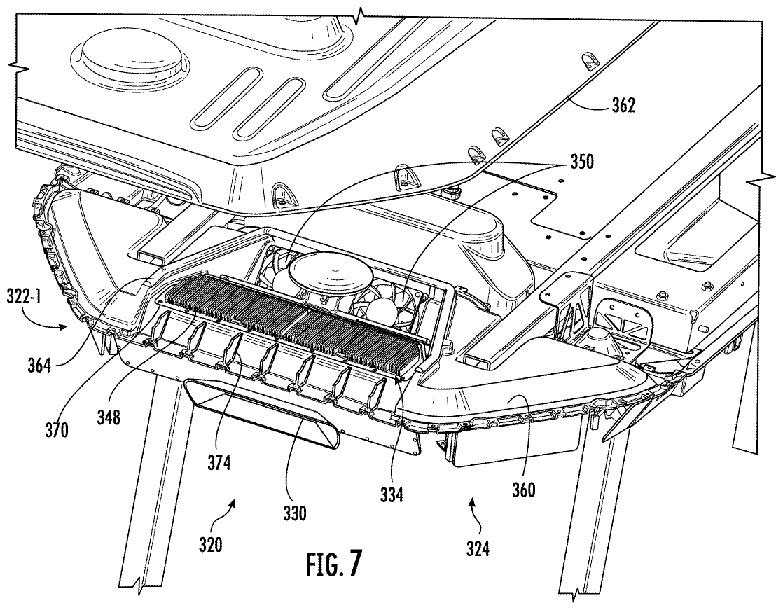

Sensor maintenance system 320 is provided as part of roof 466 of tractor 324 and facilitates the maintenance of the performance of multiple sensors in roof 466 despite the presence of airborne contaminants and/or moisture. FIG. 6 is an exploded perspective view illustrating portions of roof 466 of tractor 324 and further illustrating sensor maintenance system 320. As shown by FIG. 6, sensor maintenance system 320 comprises a pair of independent fore-aft compute enclosures 322-1 and 322-2 (collectively referred to as enclosures 322). Fore-aft compute enclosure 322-1 is located at a front end of roof 466, facing in a direction towards front wheels 452. Fore-aft compute enclosure 322-2 is located at a rear end of roof 466, facing in a rearward direction away from front wheels 452. As enclosures 322 are substantially identical to one another but for the direction and orientation of the components, the following description of enclosure 322-1 equally applies to enclosure 322-2.

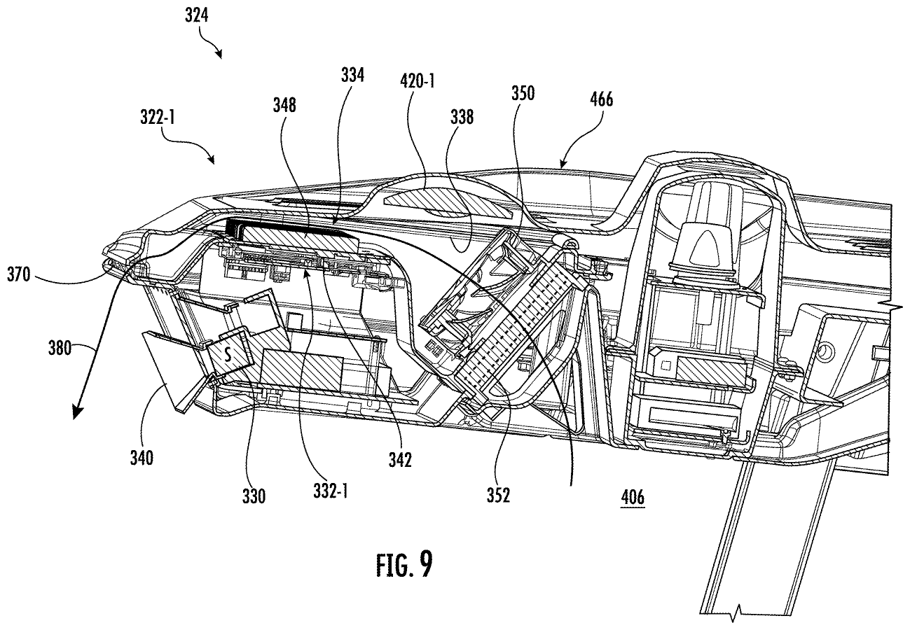

As shown by FIGS. 6, 7 and 8, fore-aft compute enclosure 322-1 comprises sensor 330, heat emitting components 332-1, 332-2 (collectively referred to as components 332), heat exchanger 334 and conduit 338 (shown in FIG. 9). Sensor 330 extends along a front edge of roof 466. In the example illustrated, sensor 330 is in the form of a stereo camera having a field of view encompassing a front environment of tractor 324. Sensor 330 has an exterior region or a front face 340 exposed to the outside environment that may include moisture or airborne contaminants. In other implementations, sensor 330 may comprise other forms of the camera, or may comprise other forms of perception sensors for which performance may be impaired due to the presence of moisture and/or airborne contaminants along the exterior of or in front of such sensors.

Heat emitting components 332 comprise components that emit heat. Heat emitting component comprise a component that may experience performance degradation or damage in response to elevated temperatures. In the example illustrated, heat emitting component 332-1 comprises a printed circuit board 342 supporting various individual heat emitting processing units 344-1, 344-2, 344-3, 344-4, 344-5, 344-6 and 344-7 (sometimes referred to as processing chips) (collectively referred to as processing units 344). Processing units 344-1, 344-2 and 344-3 carry out computer processing operations for the autonomous functioning of tractor 324. For example, processing unit 344-1, 344-2 and 344-3 may carry out processing operations to facilitate the automated guidance and steering of tractor 324 independent of operator input. In some implementations, processing units 344-1, 344-2 and 344-3 may receive signals from sensor 330 and utilize such signals in the autonomous control of tractor 324. Processing units 344-4, 344-5 and 344-6 carry out direct-current to direct current (DC-DC) operations for tractor 324. Processing unit 344-7 carries out processing operations associated with GPS antenna unit 420-1. Heat emitting component 332-2 comprises a secondary computing device for carrying out other computing operations or processes for tractor 324.

Heat exchanger 334 facilitates the removal of heat from heat emitting component 332-1 and 332-2. Heat exchanger 334 comprises thermal interfaces 346, heat sink 348 and fans 350. Thermal interfaces 346 comprise panels or layers of thermal interface material sandwiched between heat emitting components 332-1 and 332-2 and heat sink 348. In the example illustrated, thermal interfaces 346 are provided for each of the processing units 344. Interfaces 346 are sandwiched between their respective processing units 344 and heat sink 348. In some implementations, Peltier devices may be provided between the heat emitting devices and heat sink 348.

Heat sink 348 comprises a structure configured to absorb heat from heat emitting component 332, to thermally conduct and to spread the absorbed heat across a large surface area to facilitate absorption of the heat by an airflow across the heat sink 348. Heat sink 348 comprises at least one panel of material thermally coupled to heat emitting components 332 by thermal interfaces 346. In some implementations, thermal interface 346 may be omitted, wherein heat sink 348 is directly thermally coupled to the various processing units of heat emitting components 332-1. Heat sink 348 may be formed from a highly thermally conductive material such as aluminum, copper or the like. In the example illustrated, heat sink 348 comprises a series of fins which spread out heat absorbed from heat emitting component 332. In other implementations, heat sink 348 may comprise an array of thermally conductive and heat spreading pins or other structures providing a large surface area for the dispersion of heat.

Fans 350 drive air to create a pressurized airflow across the surface of heat sink 348. In the example illustrated, fans 350 draw air from an interior of cab 406 and through an air filter 352. Fans 350 cooperate with conduit 338 to direct the airflow across heat sink 348 and further direct the airflow to regions proximate to the exterior sensor 330.

Conduit 338 cooperates with fans 350 to direct the airflow generated by fans 350 across heat sink 348 and further direct the heated exhaust air from heat exchanger 334 to regions proximate to the exterior 340 of sensor 330. Conduit 338 may have various sizes, shapes and forms and may be formed by a various number of panels, baffles, pipes, plenums and the like. In the example illustrated, conduit 338 is formed by upper housing 360, roof panel 362 and seal 364.

Upper housing 360 is supported by a lower housing 368 of enclosure 322-1 and covers sensor 330, heat emitting component 332 and fans 350. Upper housing 360 includes an opening 370 in which heat sink 348 is inserted such that a lower face of heat sink 348 may be in physical contact with thermal interfaces 346 (or in direct contact with processing unit 344 when thermal interface 346 are omitted). To inhibit pressure loss, a seal or gasket may be positioned about a perimeter of heat sink 348, between heat sink 348 and upper housing 360. Upper housing 360 further comprises openings 372 through which airflow from fans 350 may pass and support baffles 374 for supporting roof panel 362.

Roof panel 362 extends over upper housing 360 and cooperates with upper housing 360 to form conduit 338 (shown in FIG. 9). In the example illustrated, to reduce airflow leakage and maintain airflow pressure, seal 364 is provided between opposite mating surfaces of upper housing 360 and roof panel 362. As shown by FIG. 9, forward edges of upper housing 360 and forward edges of roof panel 362 are spaced to form an airflow gap or passage 370 proximate to the exterior 340 of sensor 330. In the example illustrated, passage 370 may face in a somewhat downward direction so as to direct the airflow downward and across exterior 340 of sensor 330. In other implementations air discharge openings may be formed along other axes such as direct air in an upward direction across sensor 330 or in a sideways direction across sensor 330. In some implementations, the air discharge openings may direct at least portions of the airflow directly onto the outermost transparent face of sensor 330. In the example illustrated, passage 370 is substantially uninterrupted across a width of exterior 340 of sensor 330 so as to form an air curtain across the face of sensor 330.

In operation, conduit 338 directs a flow 380 of air across the sensing face 340 or exterior front of sensor 330. Flow 380 extends from interior of cab 406, through air filter 352, through blower 350, across the surfaces of heat sink 348 and through passage 370 to form an air curtain in front of sensor 330. In other implementations, passage 370 may be provided by a series of nozzles, ports or other airflow outlets. In other implementations, passage 370 may additionally or alternatively direct air towards a transparent lens cover panel, lens or face of sensor 330 to remove any accumulated moisture or debris from the lens panel or face. The generated airflow across sensor 330 may have various pressure profiles and directions. For example, in some implementations, passage 370 may be located on one or both sides of exterior 340 of sensor 330 so as to direct air in a sideways direction across face 340 of camera 330. In some implementations, passage 370 may be located below exterior 340 of camera 330 so as to direct air in upward direction in front of face 340 of camera 330.

Although the present disclosure has been described with reference to example implementations, workers skilled in the art will recognize that changes may be made in form and detail without departing from the disclosure. For example, although different example implementations may have been described as including features providing various benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

What is claimed is:

1. A sensor maintenance system comprising:
a sensor having an exterior;
a heat exchanger to output exhaust air;
a conduit for directing the exhaust air to regions proximate the exterior of the sensor.

2. The sensor maintenance system of claim 1, wherein the heat exchanger comprises:
a heat sink; and
a fan to direct air across the heat sink.

3. The sensor maintenance system of claim 2 further comprising a printed circuit board having processing units adjacent the heat sink.

4. The sensor maintenance system of claim 3, wherein the printed circuit board is electrically connected to the sensor and receives signals from the sensor.

5. The sensor maintenance system of claim 3 further comprising a vehicle having a roof, wherein the sensor, the heat exchanger, the conduit, and the printed circuit board are supported by the roof.

6. The sensor maintenance system of claim 5, the sensor faces in a forward direction and wherein the conduit directs exhaust air across a face of the sensor.

7. The sensor maintenance system of claim 5 further comprising:
a second sensor supported by the roof and facing a rearward direction;
a second heat exchanger comprising a second heat sink and a second fan to direct air across the second heat sink;
a second printed circuit board adjacent the second heat sink; and
a second conduit to direct exhaust air from the second heat exchanger across a face of the second sensor.

8. The sensor maintenance system of claim 2 further comprising a filter, wherein the fan is configured to draw air through the filter prior to directing the air across the heat sink.

9. The sensor maintenance system of claim 2, wherein the heat sink overlies the sensor.

10. The sensor maintenance system of claim 1, wherein the sensor comprises a camera.

11. The sensor maintenance system of claim 1, wherein the conduit is configured to form an air curtain across a face of the sensor.

12. A sensor maintenance method comprising:
directing cooling air across a heat exchanger that has absorbed heat from a heat emitting component; and
directing exhaust air from the heat exchanger to regions proximate an exterior of a sensor.

13. The sensor maintenance method of claim 12, wherein a fan directs the cooling air across a heat sink that has absorbed heat from the heat emitting component.

14. The sensor maintenance method of claim 12, wherein the sensor is supported by a roof of a vehicle.

15. The sensor maintenance method of claim 12, wherein the sensor comprises a camera and wherein the exhaust air is directed so as to form an air curtain across a face of the camera.
